(19) United States
(12) Patent Application Publication
(10) Pub. No.: US 2008/0298266 A1
(43) Pub. Date: Dec. 4, 2008

(54) METHOD AND SYSTEM FOR ASSESSING STATUSES OF CHANNELS

(75) Inventors: CHI-TUNG CHANG, TAIPEI (TW); CHUN-YI WU, TAIPEI (TW); TZU-WEN SUNG, TAIPEI (TW); YU-LING CHEN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: ALCOR MICRO, CORP., TAIPEI (TW)

(21) Appl. No.: 11/833,532

(22) Filed: Aug. 3, 2007

(30) Foreign Application Priority Data
Jun. 4, 2007 (TW) 96119995

(51) Int. Cl. G06F 11/00

(52) U.S. Cl. 370/252

(57) ABSTRACT

An assessment system classifies a plurality of channels to several channel groups according to the characteristics of the channel groups and assesses the status of each channel by a corresponding method, such as a period comparison method or a SNR comparison method, defined based on the channel groups. Hence, the present invention allows simpler computations to be made and a simpler circuit structure to be used.

### BACKGROUND OF THE INVENTION

1. Field of the Invention

The present invention relates to an assessment system, and more particularly to a method and system for assessing the statuses of channels.

2. Description of the Prior Art

In multi-channel communication systems, each channel transmits a signal with a package from like individual pseudo-noise sequence. In a narrow band system, the system assesses channels in two ways. In the first way, the system calculates the energy of respective signals transmitting in the corresponding channel based on the characteristics of a cyclic signal. In the second way, the system filters the received signal via a plurality of filters with the individual pseudo-noise sequence to generate the output values of the filters, and uses the output values to assess channels, wherein the channel with the greatest output value transmits the signals.

In FIG. 1, the assessment system 10 is well known in the prior arts and includes filter circuits 110, 120, 130, 140, 150, 160, and 170, and a channel assessment unit 180 that connects to each of the channels, wherein each of the filter circuits connects to a corresponding channel.

When the assessment system 10 receives an input signal, each of the filter circuits respectively filters the input signal in the corresponding channel. Next, the channel assessment unit 180 uses the output values of the filter circuits to assess the channels, wherein the output value is the energy of the signal transmission in the channel, and the output of the filter circuit.

However, the assessment system 10 is easily affected by serious background noise and multipath channel fading. These disadvantages cause an error assessment that further reduces the transmission quality and increases the period required to assess the channels. Furthermore, if the assessment system has a plurality of filters with the individual pseudo-noise sequence installed for the multi-channel communication system, all the filters will continuously operate and waste large amounts of power.

### SUMMARY OF THE INVENTION

It is the object of the present invention that the assessment system can be applied to the narrow band system and the broadband system.

It is another object of the present invention that the assessment system can ignore serious background noise and multipath channel fading and avoid the interference.

It is another object of the present invention that the assessment system can provide various assessment methods to assess each channel.

It is yet object of the present invention that the assessment system has simpler computations and a simpler circuit structure.

In order to achieve the above objects, the present invention provides an assessment system for assessing a plurality of channels. The assessment system includes a channel classification unit, an energy calculation and driving unit, a period calculation unit, a SNR comparison unit, and a channel assessment unit.

First, the assessment system classifies the channels. The input signal is transmitted to the energy calculation and driving unit via the classified channels. The energy calculation and driving unit calculates the energy of the input signal for further driving the period calculation unit and the SNR comparison unit. Moreover, the energy calculation and driving unit selectively performs the period comparison method and the SNR comparison method to assess the channels based on the segments of the channels.

Next, the driven period calculation unit performs the period comparison method for further counting the periods of the signals transmitting in the sections of the channels. The driven SNR comparison unit performs the SNR comparison method for further calculating the output values of the sections of the channels and calculating the average noise intensity of the background noise of the input signal.

The channel assessment unit compares the periods provided by the period calculation unit and compares the frequency in which each output value is greater than the average noise intensity. Hence, the channel assessment unit can use the above comparison result to assess the channels.

### BRIEF DESCRIPTION OF THE DRAWINGS

The above and further advantages of this invention may be better understood by referring to the following description, taken in conjunction with the accompanying drawings, in which:

FIG. 1 is a block diagram of the assessment system of the previous invention;

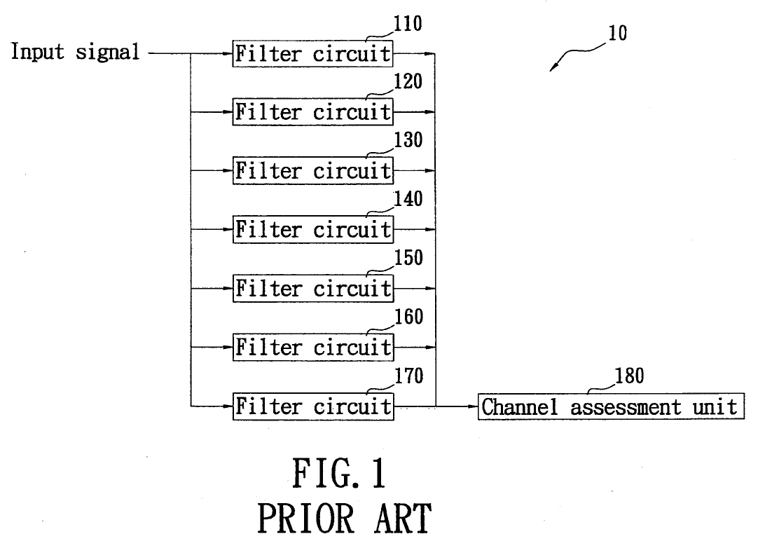

FIG. 2 is a block diagram of the assessment system of the present invention; and

FIG. 3 is a flowchart of the assessment method of the present invention.

The drawings will be described further in connection with the following detailed description of the present invention.

### DETAILED DESCRIPTION OF THE PREFERRED EMBODIMENTS

The present invention is applied to a communication system with multiple channels, specifically a multi-band OFDM alliance (MBOA) communication system. The assessment system of the present invention can not only assess the channels of the narrow band system, but can also assess the channels of a broadband system and even an ultra wide-band system. It should be noted that the present invention could ignore serious background noise, multipath channel fading, and interference.

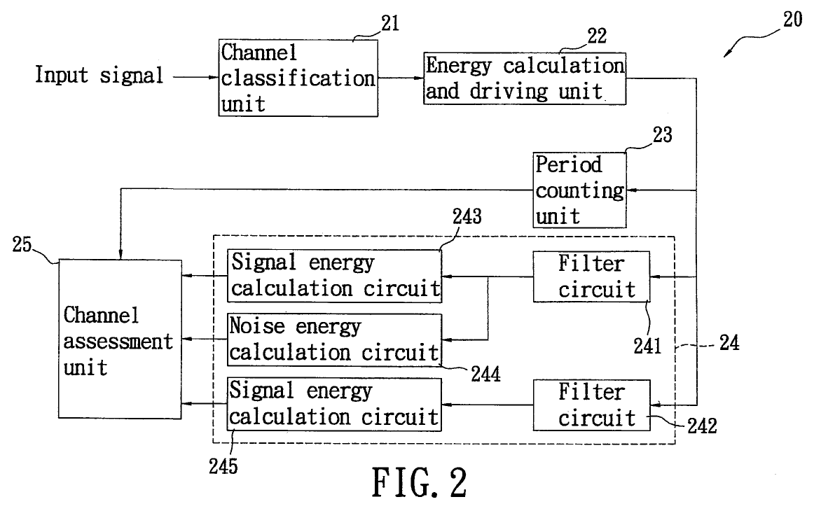

In FIG. 2, the assessment system 20 includes a channel classification unit 21, an energy calculation and driving unit 22, a period counting unit 23, a signal noise ratio (SNR) comparison unit 24, and a channel assessment unit 25. For example, the present invention is a MBOA system and includes seven channels used for transmitting signals.

The channel classification unit 21 receives an input signal and classifies the channels into five channel groups based on the characteristics of the channels. The first channel group and the second channel group respectively include two channels with similar characteristics. The third channel group, the fourth channel group, or the fifth channel group respectively includes one channel with independent characteristics.

The energy calculation and driving unit 22 connects to the channel classification unit 21 and calculates the energy of the input signal. Next, according to the level of energy of the input signal, the energy calculation and driving unit 22 determines whether to drive the period counting unit 23 and the SNR comparison unit 24 to operate.

The period counting unit 23 connects to the energy calculation and driving unit 22 and respectively counts the signal transmission periods in the channel of the third channel group, the fourth channel group, or the fifth channel group according to the energy of the input signal. That is, the period counting unit 23 determines whether to count the signal transmitting periods in the third channel group, the fourth channel group, or the fifth channel group according to the detected level of energy of the input signal.

The SNR comparison unit 24 connects to the energy calculation and driving unit 22, calculates an average noise intensity of the background noise of the input signal, and respectively calculates the output values of the channels of the first channel group and the second channel group.

For example, in the first embodiment of the present invention, the SNR comparison unit 24 includes a filter circuit 241, a filter circuit 242, a signal energy calculation circuit 243 connected to the filter circuit 241, a noise energy calculation circuit 244 connected to the filter circuit 241, and a signal energy calculation circuit 245 connected to the filter circuit 242. If the filter circuit 241 filters the signal transmission in one channel of the first channel group, the filter circuit 242 will filter the signal transmission in the other channel of the first channel group.

The signal energy calculation circuit 243 calculates the output value of the signal that is provided by the filter circuit 241 and transmits via one channel of the first channel group. The signal energy calculation circuit 245 calculates the output value of the signal that is provided by the filter circuit 242 and transmits via one channel of the first channel group. The noise energy calculation circuit 244 calculates an average noise intensity of the input signal based on the signal provided by the filter circuit 241.

Similarly, if the filter circuit 241 filters the signal transmission in one channel of the second channel group, the filter circuit 242 will filter the signal transmission in the other channel of the second channel group. Wherein, the above output values are the outputs of the above filter circuits and the energy levels of the signals transmitting in the above channels.

In the second embodiment of the present invention, the noise energy calculation circuit 244 and the signal energy calculation circuit 245 connect to the filter circuit 242, and the signal energy calculation circuit 243 connects to the filter circuit 241.

According to the above description, the SNR comparison unit 24 can be the calculation and filtering means to calculate the average noise intensity of the background noise of the input signal and calculate the output value of the signal transmission in each channel of the first channel group and the second channel group. Hence, the filter circuits in the first and second embodiment can be channel selection filters (CSF).

The channel assessment unit 25 connects to the period counting unit 23 and the SNR comparison unit 24 and respectively counts the signal transmission period in each channel of the third channel group, the fourth channel group, or the fifth channel group, the average noise intensity, and the output value of the signal transmission in each channel of the first channel group and the second channel group. Next, the channel assessment unit 25 assesses the status of each channel of the first through the fifth groups to establish the channel that the input signal is transmitting within based on the comparison of the periods and the frequency in which each output value is greater than the average noise intensity.

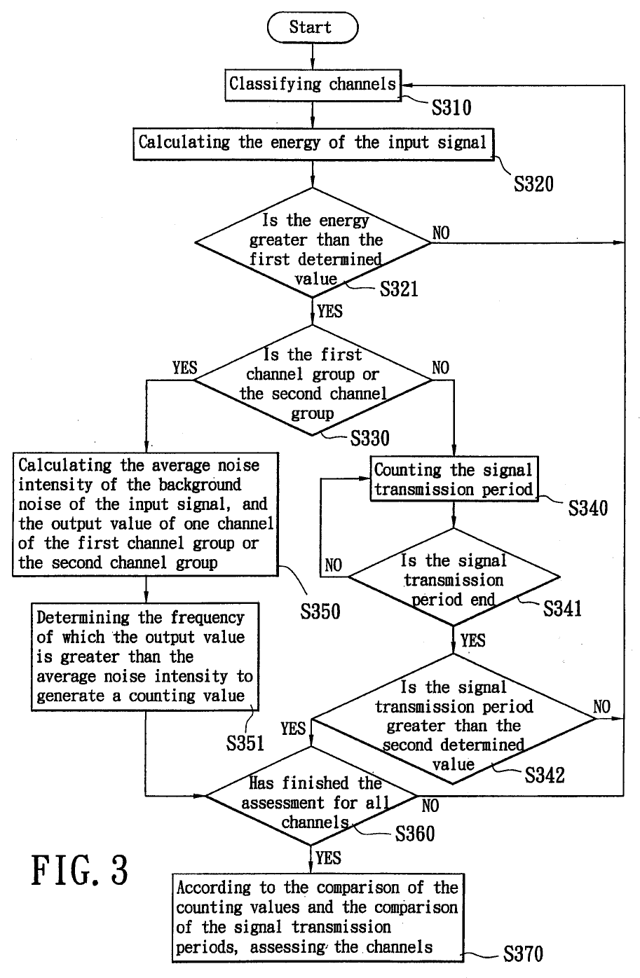

In FIG. 3, a flowchart of assessing the statuses of channels of the present invention is shown. First, the assessment system 20 classifies the seven channels used for transmitting an input signal into five channel groups based on the characteristics of the channels, in S310. The first channel group includes the first channel and the second channel. The second channel group includes the third channel and the fourth channel. The third channel group includes the fifth channel. The fourth channel group includes the sixth channel. The fifth channel group includes the seventh channel.

As the input signal is passed through the energy calculation and driving unit 22 via the classified channels, the energy calculation and driving unit 22 calculates the energy of the input signal in S320 and determines whether the energy of the input signal is greater than a first determined value in S321. Wherein, the energy of the input signal is presented as follows:

$${E}_{i n} ( t ) = {\sum }_{i = 0}^{N - 1} {( \vert {S}_{i} ( t ) \vert )}^{2}$$

In the first expression, Eᵢₙ(t) is the energy of the input signal, and Sᵢ is the ith signal value transmitted to the corresponding filter.

If the energy of the input signal is less than the first determined value at a certain assessment period, no signal will be transmitted via the assessed

If the signal transmission period has not ended, the period counting unit 23 continuously performs counting. If the signal transmission period has ended, all of the packages of the input signal have been received, and the period counting unit 23 further transmits the signal transmission period of the signal transmission via one channel of third channel group, the fourth channel group, or the fifth channel group, to the channel assessment unit 25. Next, the channel assessment unit 25 determines whether the signal transmission period is greater than a second determined value, in S342.

In an assessment period, if the signal transmission period is less than the second determined value, no signal is transmitted via the detected channel, and the assessment system 20 tries again to receive the input signal via the next channel. If the signal transmission period is greater than or equal to the second determined value, the assessment system 20 has successfully received the input signal. The channel assessment unit 25 then determines whether to assess the channels, that is, to determine whether the channel assessment unit 25 has obtained all of the signal transmission periods of the third channel group, the fourth channel group, or the fifth channel group, in S360.

According to S330, if the signal is provided by the first channel group or the second channel group, the SNR comparison unit 24 processes the signal and further assesses the channels of the first channel group or the second channel group by the SNR comparison method.

According to S350, the filter circuit 241 transmits the signal via one channel of the first channel group to the signal energy calculation circuit 243 and the noise energy calculation circuit 244, and the filter circuit 242 then channel, and the assessment system 20 clarifies the assessed channel is clean. Furthermore, the process returns to S310, and the assessment system 20 tries to receive the input signal again.

If the energy of the input signal is greater than the first determined value, the input signal may transmit via one of the channels. Furthermore, the energy calculation and driving unit 22 drives the period counting unit 23 and the SNR comparison unit 24 to operate.

In one case, the SNR comparison unit 24 processes the signal transmission via one channel of the first channel group and the second channel group, and the period counting unit 23 processes the signal transmission via one channel of the third channel group, the fourth channel group, or the fifth channel group. The channel selection filters in the driven SNR comparison unit 24 further determine whether the signal is provided by the first channel group or the second channel group, in S330. The determined result is associated with the assessment method for the channel assessment, wherein the assessment method can be the period comparison method or the SNR comparison method.

When the signal is not provided by the first channel group or the second channel group, be provided by the third, the fourth, or the fifth channel group. The period counting unit 23 receives the transmitted signal via one channel of the third channel group, the fourth channel group, or the fifth channel group, and assesses the channels via the period comparison method. That is, the period counting unit 23 counts in real time the signal transmission period via one channel of the groups in S340, and determines whether the signal transmission period of the signal has ended, i.e. to finish counting in S341. transmits the signal to the signal energy circuit 245. The signal energy circuit 243 and 245 further respectively calculate the output value of the signal transmission in each channel of the first channel group. The noise energy calculation circuit 244 further calculates the average noise intensity of the background noise of the input signal. The output values and the average noise intensity are transmitted to the channel assessment unit 25. Wherein, the output value of each filter is presented as follows:

$${E}_{f} ( t ) = {\sum }_{i = 0}^{N - 1} {S}_{i} ( t ) \cdot {W}_{Ki} \qquad K = 1 … {L}_{Group 1}$$

In the second expression, E_{f} (t) is the output value of the filter, W_{Ki} is the coefficient of the ith filter, and L_{Group1} is the number of the filters for the first channel group.

Next, in S351, the channel assessment unit 25 respectively counts the frequency in which each of the output values is greater than the average noise intensity, to generate a corresponding counting value, wherein the counter (not shown) counts once when the output value is greater than the average intensity once.

Moreover, the channel assessment unit 25 continuously determines whether to finish receiving the average noise intensity and all of the output values of the first channel group and the second channel group in S360.

If the channel assessment unit 25 has not received all of the characteristics of the channel groups yet, it continuously calculates and receives the characteristics of the next channel group, i.e. the second channel group. If the channel assessment unit 25 has received all of the characteristics of the first channel group and the second channel group, it calculates the characteristics for further assessing the status of each channel, in S370. That is, the channel assessment unit 25 compares the counting values of the first channel group and the second channel group. If one channel in the first channel group or the second channel group has the smallest counting value, the signal is transmitted via the channel with the smallest counting value.

Similarly, the channel assessment unit 25 compares the periods of the third channel group, the fourth channel group, or the fifth channel group. If one channel in the third, the fourth, or the fifth channel group has the period that is greater than the second determined value, the signal is transmitted via the channel that has the period that is greater than the second determined value.

An advantage of the present invention is that the present invention can be applied to a narrow band system and a broadband system.

Another advantage of the present invention is that the present invention can ignore serious background noise, multipath channel fading, and interference.

Another advantage of the present invention is that channels are classified into a plurality of channel groups based on the characteristics of the channels.

Another advantage of the present invention is that the present invention provides a corresponding assessment method to assess each channel based on its characteristics.

Another advantage of the present invention is that the present invention uses the period of the signal transmission in each channel to assess the channels.

Another advantage of the present invention is that the present invention uses the frequency in which each output value of the channels is greater than the average noise intensity of the background noise of the input signal, to assess the channels.

Yet another advantage of the present invention is that the present invention can have simpler computations and a simpler circuit structure.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An assessment method for assessing the statuses of channels used for transmitting an input signal, while receiving the input signal, and the assessment method comprising:
calculating the energy of the input signal;
counting each signal transmission period in the section of the channels according to the energy of the input signal;
calculating an average noise intensity of the input signal and respectively calculating the output value of each respective signal transmission in the other section of the channels;
counting the frequency in which each of the output values is greater than the average noise intensity to generate a corresponding counting value; and
assessing the status of each respective channel according to the comparison of the signal transmission periods and the comparison of the counting values.

2. The assessment method according to claim 1, further comprising determining whether each of the signal transmission periods is greater than a determined value, for further performing the comparison of the signal transmission periods.

3. The assessment method according to claim 2, wherein the step of determining whether each of the signal transmission periods is greater than the determined value further comprises:
not transmitting any signals in the section of the channels if the signal transmission periods are less than the determined value at the end of a channel detection period; and
comparing the signal transmission periods to determine the statuses of the section of the channels if the signal transmission periods are greater than or equal to the determined value.

4. The assessment method according to claim 1, further comprising counting the signal transmission periods in the section of the channels if the energy of the input signal is greater than a determined value.

5. An assessment method for assessing the statuses of channels used for transmitting an input signal, while receiving the input signal, the assessment method comprising:
classifying the channels into a plurality of channel groups;
calculating the energy of the input signal;
selecting a signal transmission period comparing means to assess the status of the corresponding section of the channels of the channel groups; and
selecting a SNR comparing means to assess the status of the other corresponding section of the channels of the channel groups.

6. The assessment method according to claim 5, wherein the step of classifying the channels is based on the characteristics of the channels.

7. The assessment method according to claim 5, wherein the channels are classified into five channel groups, two of the channel groups respectively comprising two channels with similar characteristics, and the other channel groups respectively comprising one channel with independent characteristics.

8. The assessment method according to claim 7, wherein the channel groups respectively comprise only one channel and use the signal period comparing means to assess the statuses of the sections of the channels, and the other channel groups respectively comprising two channels and use the SNR comparing means to assess the statuses of the other sections of the channels.

9. The assessment method according to claim 5, wherein the signal period comparing means comprises:
respectively counting each signal transmission period in the section of the channel groups according to the energy of the input signal; and
comparing the counting values of the periods for further assessing the status of each channel of the section channel groups.

10. The assessment method according to claim 9, further comprising counting each signal transmission period in the section of the channel groups if the energy of the input signal is greater than a determined value.

11. The assessment method according to claim 9, further comprising determining whether the signal transmission periods are less than a determined value.

12. The assessment method according to claim 11, wherein the step of determining whether the signal transmission periods are less than the determined value comprises:
not transmitting signals in the channels if the signal transmission periods are less than the determined value at the end of a channel detection period; and
comparing the signal transmission periods to determine the status of each channel if the signal transmission periods are greater than or equal to the determined value.

13. The assessment method according to claim 5, wherein the SNR comparison method comprises:
calculating an average noise intensity of the input signal;
calculating the output value of each channel of the other section channel groups;
counting the frequency in which each of the respective output values is greater than the average noise intensity, for further generating a corresponding counting value; and
determining the status of each channel of the section channel groups according to the comparison of the counting values.

14. An assessment system for determining the statuses of channels used for transmitting an input signal, while receiving the input signal, the assessment method comprising:
a channel classification unit receiving the input signal and classifying the channels used to transmit the input signal;
a period counting unit counting the signal transmission periods of the sections of the classified channels;
a SNR comparison unit calculating an average noise intensity of the input signal and calculating the output values of the other sections of the classified channels; and
a channel assessment unit comparing the signal transmission periods and comparing the frequency of which each output values is greater than the average noise intensity, for further assessing the statuses of the channels.

15. The assessment system according to claim 14, further comprising an energy calculation and driving unit connected to the channel classification unit, the period counting unit, and the SNR comparison unit and calculating the energy of the input signal for further driving the period counting unit and the SNR comparison unit based on the energy of the input signal to operate.

16. The assessment system according to claim 14, wherein the SNR comparison unit comprises at least one filter circuit, a noise energy calculation circuit, and at least one signal energy calculation circuit.

17. The assessment system according to claim 16, wherein the filter circuit connects to the energy calculation and driving unit and filters the signals transmitting in the SNR comparison unit.

18. The assessment system according to claim 16, wherein the noise energy calculation circuit connects to the filter circuit and calculates an average noise intensity of the background noise of the input signal.

19. The assessment system according to claim 16, wherein the signal energy circuit connects to the filter circuit and calculates the output values of the channels in the SNR comparison unit.
